(19) United States
(12) Patent Application Publication
(10) Pub. No.: US 2016/0150913 A1
(43) Pub. Date: Jun. 2, 2016

(54) GRILLER

(71) Applicant: Joseph Chadwick, Bridport (GB)

(72) Inventor: Joseph Chadwick, Bridport (GB)

(21) Appl. No.: 14/556,070

(22) Filed: Nov. 28, 2014

(51) Int. Cl. A47J 37/07

(52) U.S. Cl. CPC A47J 37/0772

(57) ABSTRACT

A device for grilling, barbecuing, and cooking over open fires enables the user to evenly cook sausages, hotdogs, ears of corn, kebabs and marshmallows, and so on. The cooking is done on four sides and prevents burning. The device secures the food items being cooked such that they do not fall. The device includes a wire frame container for elongated food items such as hot dogs and ears of corn, and also for loose items such as marchmallows. The device also provides a way of securing the food item inside the container, so that it does not fall out during cooking. Additionally, the device provides a numerical designation on one end of the container, to facilitate correct turning of the food item during cooking.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a device and apparatus for grilling food items.

### BACKGROUND OF THE INVENTION

It is a problem in the art to conveniently grill food items such as hotdogs, ears of corn, marchmallows, and the like.

Many types of utensils are known for grilling, barbecuing, and cooking over open fires. Such items include, for example, a stick; tongs; spatulas; and also flat grills formed of wire found on many barbecue grills.

It remains a problem in the art to evenly cook the sausage/hotdogs, ears of corn, kebabs and marshmallows, etc., on four sides and prevent burning. It is also a problem to secure the food items being cooked such that they do not fall.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a device useful for grilling, barbecuing, and cooking over open fires.

The device of the present invention provides an apparatus for grilling, barbecuing, and cooking over open fires. The present invention enables the user to evenly cook the sausage/hotdogs, ears of corn, kebabs and marshmallows, etc., on four sides and prevent burning. It is also a problem to secure the food items being cooked such that they do not fall.

More specifically, the device according to the present invention provides a wire frame container for elongated food items such as hot dogs and ears of corn. The present invention also provides a way of securing the food item inside the container, so that it does not fall out during cooking.

Additionally, the apparatus of the present invention provides a numerical designation on one end of the container, to facilitate correct turning of the food item during cooking.

Other objects and advantages of the present invention will be more readily apparent from the following detailed description when read in conjunction with the accompanying drawings.

### BRIEF DESCRIPTION OF THE DRAWINGS

FIG. 1 is a perspective assembly view of a first embodiment of a griller, according to the present invention.

FIG. 2 is a front elevational view of an end member of the griller of FIG. 1.

FIG. 3 is a side elevational view of the end member of FIG. 2.

FIG. 4 is a rear elevational view of the end member of FIG. 2.

FIG. 5 is a perspective view of another embodiment of the present invention similar to FIG. 1 and having a second type of handle.

FIG. 6 is a perspective view of another embodiment of the present invention similar to FIGS. 1 and 2, and having a second type of end member.

FIG. 7 is a perspective view of the griller of FIG. 5, as viewed from an opposite side and showing a food item held therein.

FIG. 8 is a front perspective view of the three embodiments of FIGS. 1-7, in use with food items held therein.

FIG. 9 is an enlarged perspective view of a closure portion, usable with any of the griller embodiments.

FIG. 10 is a side view of a further embodiment of the griller, having a top opening portion hinged at one end, according to the present invention.

FIG. 11 is a perspective view of a still further embodiment of the griller, having a top opening portion hinged along one side, according to the present invention.

FIG. 12 is an assembly view of the griller of FIG. 11.

FIG. 13 is an assembly view of another embodiment of the griller of the present invention having a top side and a bottom side.

FIG. 14 is a side schematic view of the griller of FIG. 14 showing a food item being held therein, the food item being shown in section.

### DETAILED DESCRIPTION OF THE INVENTION

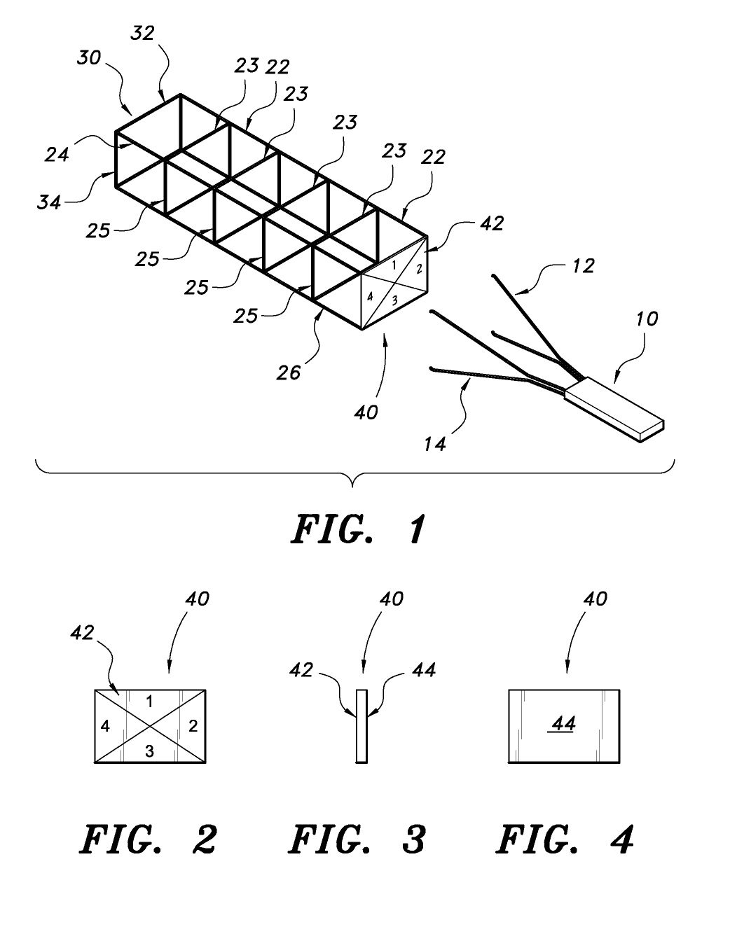

FIG. 1 is a perspective assembly view of a first embodiment of a griller 100 having a holder portion 20, and end member 40, and a handle portion 10. When assembled, the handle portion 10 is connected to the holder portion by wire portions 12 and 14. In assembled form, the ends of the wire portions 12 and 14 are fixedly connected to the corners of the end member 40.

The end member 40 has a front face 42 bearing indicia thereon. Here, the indicia is in the form of numerals 1, 2, 3, and 4, which serve as a visual aid to the user when grilling. For example, it is easier to know which way to rotate the griller 100 during cooking, by visual reference to the numerals. Thus, the griller 100 can be said to have sides 1, 2, 3, and 4. For example, when side 1 is down for a period of time, the user knows to rotate the griller so that numeral 2 is down for a period of time, then side 3, and then side 4. This prevents accidentally rotating the wrong way, so that a particular side is turned to the heat twice while another side remains unheated.

The holder portion 20 is formed by a plurality of wires. Specifically, the holder portion 20 incloudes four longitudinal wires, which include wires 22, 24, and 26, with the remaining longitudinal wire unnumbered in FIG. 1. The wires 22 and 24 are connected by a plurality of cross wires 23, and the wires 24 and 26 are connected by a plurality of cross wires 25. And end 30 is open so as to easily receive a food item such as a sausage, hot dog, ear of corn, and the like. The end 30 is bounded by end wires 32, 34 in FIG. 1. In use, the food item is placed into the holder portion 20 through the open end 30, and as long as held level or upright the food item will not fall out of the holder portion 20. The food item can be dislodged by tilting of the holder portion downwardly, i.e. with the open end 30 lower than the handle portion 10.

In FIG. 1, the holder 10 is shown as a solid member connected to the wire portions 12 and 14. It is contemplated that any known type of handle can be used for the handle 10 in this view, and the choice of handle would be within the ambit of skill of any one having skill in the cooking utensil art.

The griller 100 serves as an apparatus for grilling, barbecuing, and cooking over open fires. The griller 100 of the present invention enables the user to evenly cook the sausage/hotdogs, ears of corn, kebabs and marshmallows, etc., on four sides and prevent burning. The griller 100 also secures food items being cooked such that they do not fall out.

FIG. 2 is a front elevational view of the end member 40 of the griller 100 of FIG. 1. In this view, the front side 42 is visible, bearing the indicia 1, 2, 3, and 4. While the indicia 1, 2, 3, and 4 is used in the preferred embodiment, it will be understood that other indicia could be used. The end member 40 can be composed of solid metal, for example, or can be composed of ceramic or other material not subject to melting when exposed to cooking heat.

FIG. 3 is a side elevational view of the end member 40 of FIG. 2. In this view, the front side 42 and a rear side 44 are indicated.

FIG. 4 is a rear elevational view of the end member 40 of FIG. 2. This view shows the rear side 44 of the end member 40. While the end member 40 is shown as rectangular and solid, it will be understood that other shapes and forms can be used within the scope of the present invention, for example a rounded shape can be used, and also the end member can be formed by wires so that it is somewhat perforated to allow air flow therethrough.

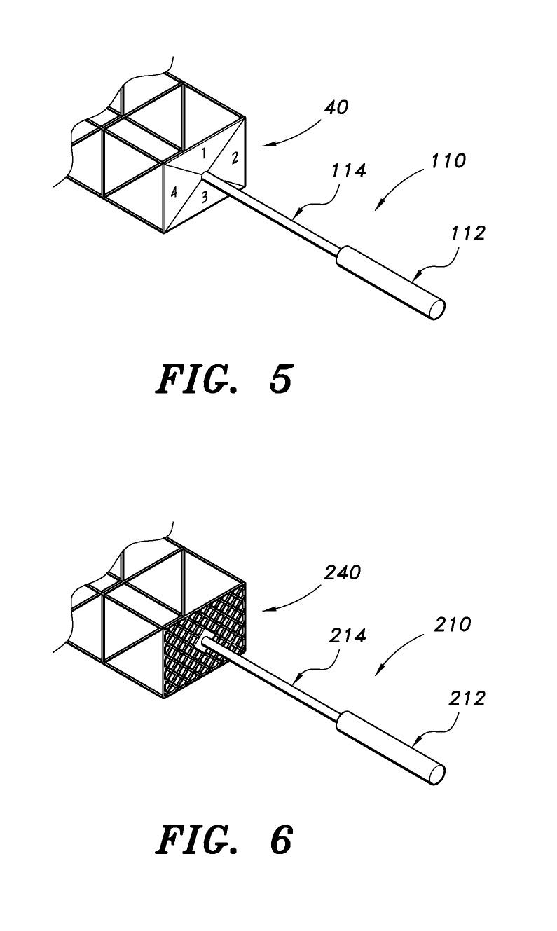

FIG. 5 is a perspective view of another embodiment of the griller 100 similar to that of FIG. 1 and having a second type of handle 110. This handle has a grip portion 112 and a connector rod 114. The connector rod 114 is connected to the center of the end member 40. It can be fastened by a threaded member (not shown), by welding, or by other securing means known to any one having skill in the cooking utensil arts.

FIG. 6 is a perspective view of another embodiment of the griller 100 which is similar to that of FIGS. 1 and 2, and having a second type of end member 240. Here, the end member 240 is formed by criss-crossing wires, so that it allows air flow therethrough. A handle 210 is shown having a gripping portion 212 and a connector rod 214, similar to that of FIG. 5 described above.

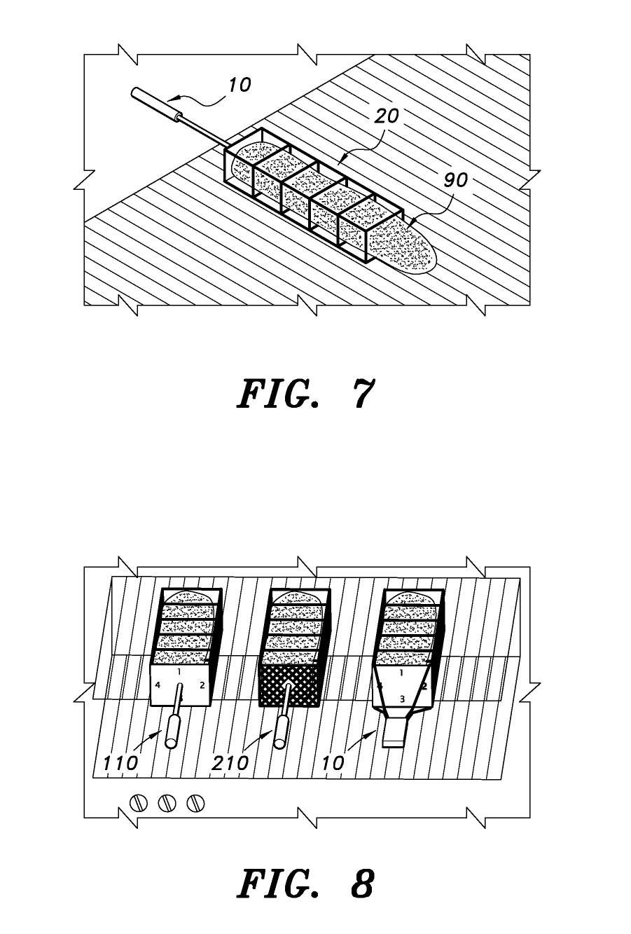

FIG. 7 is a perspective view of the griller 100 having the handle portion 10 and the holder portion 20 as shown in the preceding figures, and showing a food item 90 (which can be a corn dog, hot dog, or sausage, for example) held in the holder portion 20. The griller 100 is shown disposed over a barbecue grill (unnumbered). This view is similar to that of FIG. 5, as is viewed from an opposite side.

FIG. 8 is a front perspective view of the three embodiments of the griller 100 of FIGS. 1-7, in use with food items held therein. These embodiments are shown disposed over a barbecue grill, as an example of use in cooking.

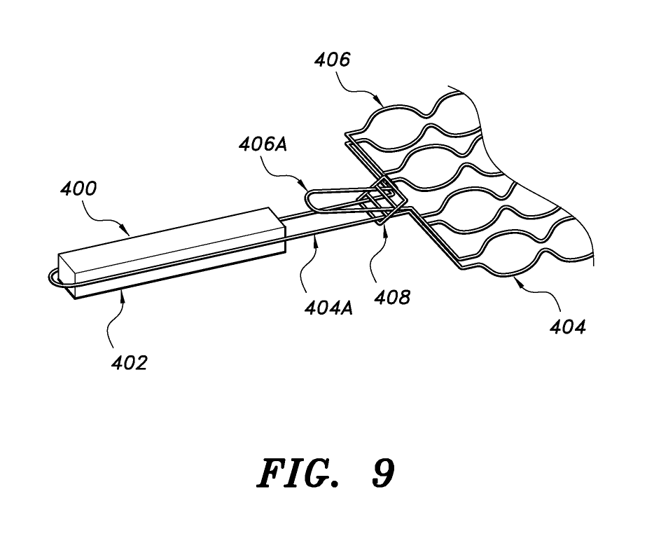

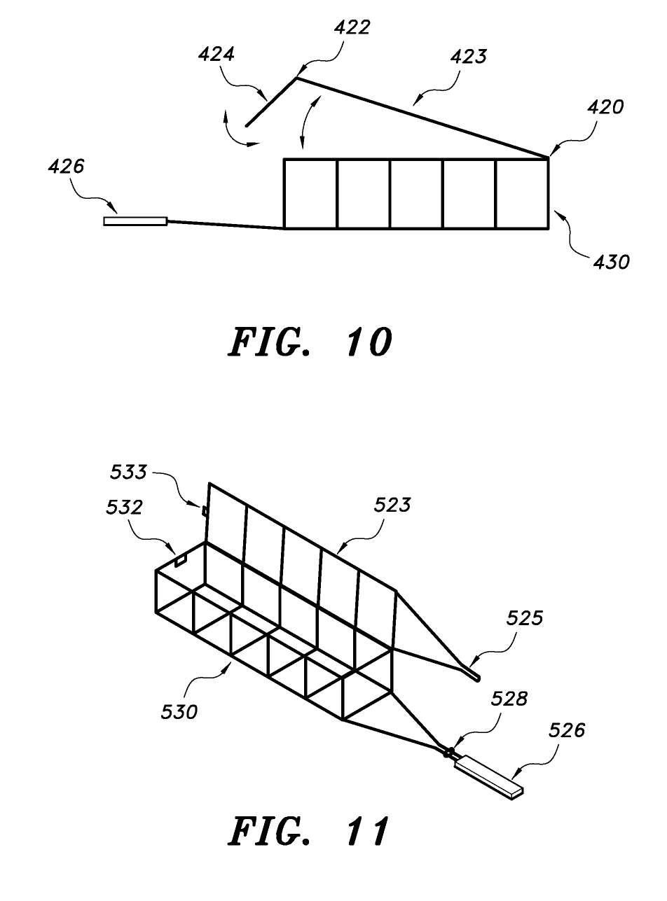

FIG. 9 is an enlarged perspective view of a closure portion 400, usable with any of the griller embodiments. This is a known type of closure, and operates as follows. A handle portion 402 includes a wire portion 404A that is connected to a lower wire member 404. An upper wire member 406 is movable (as by pivoting, folding, sliding, etc.) and has a tab portion 406a that can overly the wire portion 404A. A slide member 408 has a lower opening that surrounds the wire portion 404A and can slide along the wire portion 404A. The slide member 408 also has a second opening for receiving the tab portion 406A, so that the member 408 can retain the members 404 and 406 together once the slide member is moved sufficiently far along the tab portion 406A to the position shown in FIG. 9.

FIG. 10 is a side view of a further embodiment of the griller 100, having a top opening portion 423 hinged at one end 420, and having a closure end 424 that is pivotable in the manner shown by the double-headed arrows. In this view, the end portion 430 in this embodiment is preferably closed. Here, the end 424 can be secured by any fastening means known to any one having skill in the cooking utensil arts, such as a snap fit, a clasp, a pivotable bar, and so on.

FIG. 11 is a perspective view of a still further embodiment of the griller 100, having a pivotable top opening portion 523, hinged along one side, according to the present invention. Here, there is a tab portion 525, a slide member 528, and handle 526, such that the pivotable top opening portion can be secured in place by a mechanism such as that shown in FIG. 9. Here, an added snap fastener is shown having mating elements 532 and 533; this portion can be omitted or can be replaced by other known fastener types, i.e. by any fastening means known to any one having skill in the cooking utensil arts.

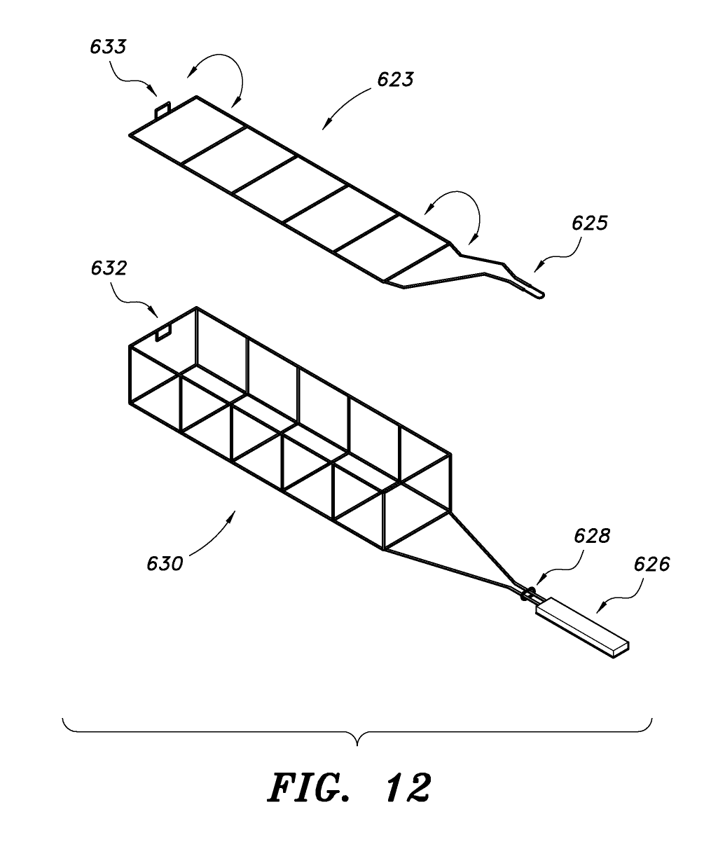

FIG. 12 is an assembly view of the griller of FIG. 11. Here, the parts are numbered such that the top portion 623 has a fastener 633 and a tab portion 625, and can be rotated as shown by the double-headed arrow. The lower portion 630 has a fastener 632 and a handle 626 with a slide fastener 628.

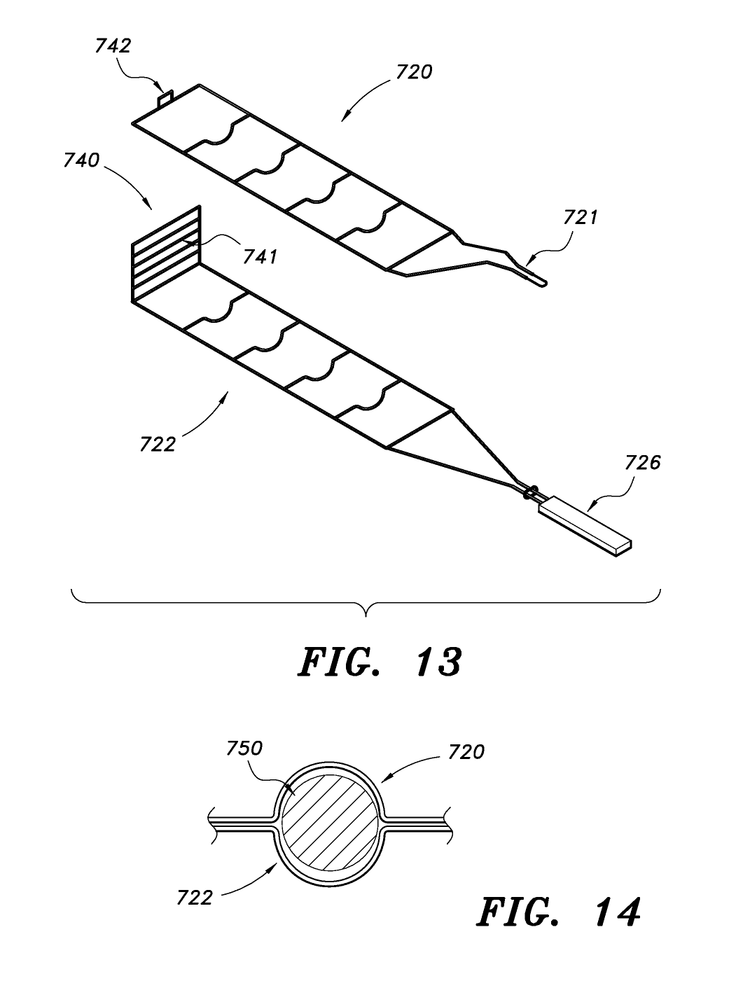

FIG. 13 is an assembly view of another embodiment of the griller of the present invention having a top side 720 and a bottom side 722. The handle portion 726 is secured in use to a tab portion 721 by a slide fastener (unnumbered in this view). Here, a pivot element 742 is provided in the top member 720 which can fit between any adjacent bars of a grating member 741, so that the spacing between the top side 720 and the bottom side 722 is adjustable.

FIG. 14 is a side schematic view of the griller 100 of FIG. 14 in use, showing a food item 750 being held therein. In this view, the food item 750 is shown in section.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A griller for holding edible items for cooking, comprising:
a holder portion having a wire frame, said wire frame having four substantially parallel longitudinal wire members and a plurality of side members connecting said longitudinal parallel wire members to form an enclosure having a first end and a second end;
an end member closing the first end of said enclosure, said end member bearing indicia thereon;
said second end being open, and said enclosure being adapted to receive items for cooking through said open second end;
a handle connected to said first end.

2. The griller of claim 1, wherein said indicia comprises the numerals 1, 2, 3, and 4; and wherein said numerals 1, 2, 3, and 4 correspond to four sides of said holder portion.

3. The griller of claim 1, wherein said handle is connected to said end member by four wire members, each of said four wire members being connected at a respective corner of said end member.

4. The griller of claim 1, further comprising a rod member for connecting said handle to a central region of said end member.

5. The griller of claim 1, wherein said end member is composed of criss-crossing wire members that permit air flow therethrough.

6. A griller for holding edible items for cooking, comprising:
a lower holder portion forming a three-sided enclosure, and a top holder portion pivotably connected at a distal end of said three-side enclosure such that said enclosure can be opened and closed by movement of said top holder portion; said lower holder portion being formed by a wire frame having four substantially parallel longitudinal wire members and a plurality of side members connecting said longitudinal parallel wire members;
a pivotable end member disposed at a proximal end of said top holder portion, for closing a proximal end of said enclosure; and
a handle connected to said lower holder portion.

7. The griller of claim 6, wherein said handle is connected to said lower holder portion by at least one wire member.

8. A griller for holding edible items for cooking, comprising:
a lower holder portion forming a three-sided enclosure, and a top holder portion pivotably connected at a side edge of said three-side enclosure such that said enclosure can be opened and closed by pivotable movement of said top holder portion; said lower holder portion being formed by a wire frame having four substantially parallel longitudinal wire members and a plurality of side members connecting said longitudinal parallel wire members; and
a handle connected to said lower holder portion.

9. The griller of claim 8, further comprising a snap connector portion disposed at a distal end of said lower holder portion, and a mating snap connector portion disposed at a distal end of said upper holder portion, whereby said snap connector portion connects said upper holder portion and said lower holder portion.

10. The griller of claim 8, further comprising a first slide connector portion disposed at a proximal end of said lower holder portion, and a second slide connector portion disposed at a proximal end of said upper holder portion; and further comprising a slide member that can slide into and out of engagement with said first and second slide connector portions, whereby said slide member can selectively connect said upper holder portion and said lower holder portion.
